(19) United States
(12) Patent Application Publication
(10) Pub. No.: US 2025/0131324 A1
(43) Pub. Date: Apr. 24, 2025

(54) UTILIZATION OF MODEL FEATURES FOR MACHINE LEARNING PREDICTION

(71) Applicant: Capital One Services, LLC, McLean, VA (US)

(72) Inventors: Trijeet SETHI, McKinney, TX (US); Muralikumar VENKATASUBRAMANIAM, Plano, TX (US)

(21) Appl. No.: 18/491,312

(22) Filed: Oct. 20, 2023

(51) Int. Cl. G06N 20/00; G06F 9/54

(52) U.S. Cl. CPC G06N 20/00; G06F 9/547

(57) ABSTRACT

In some implementations, a device may receive a request for a machine learning prediction. The device may access a feature store that stores data associated with a plurality of possible machine learning model features, wherein accessing the feature store comprises performing a remote procedure call (RPC) to generate a new data object at the feature store, the new data object having the device subscribed as a client. The device may receive, from the feature store in connection with the device being subscribed to the new data object as the client, a set of values associated with a composite feature. The device may execute a machine learning model using the set of values associated with the composite feature. The device may output a machine learning prediction based on a result of executing the machine learning model using the set of values associated with the composite feature.

### BACKGROUND

The WebSocket protocol, which may be referred to as “WebSockets,” is a communications protocol that facilitates full-duplex communication over a single transmission control protocol (TCP) connection. WebSockets enables establishment of a persistent bidirectional communication link between a client device and a server device, thereby allowing for real-time data transfer. The WebSocket protocol may be associated with low overhead and minimal latency, and can be used for continuous data exchange in web applications, data centers, and/or other use cases.

### SUMMARY

Some implementations described herein relate to a device for machine learning model prediction. The device may include one or more memories and one or more processors coupled to the one or more memories configured to cause the device. The one or more processors may be configured to receive a request for a machine learning prediction. The one or more processors may be configured to access a feature store that stores data associated with a plurality of possible machine learning model features. The one or more processors may be configured to receive, from the feature store, a set of values associated with a composite feature using a protocol associated with pushing model data to subscribed client devices, wherein the composite feature is a secondary or higher feature based on one or more primary features calculated at the feature store. The one or more processors may be configured to execute a machine learning model using the set of values associated with the composite feature to obtain the machine learning prediction using a result of executing the machine learning model using the set of values associated with the composite feature. The one or more processors may be configured to output the machine learning prediction to permit the machine learning prediction to be used to perform one or more actions.

Some implementations described herein relate to a method of machine learning model prediction. The method may include receiving, by a device, a request for a machine learning prediction. The method may include accessing, by the device, a feature store that stores data associated with a plurality of possible machine learning model features, wherein accessing the feature store includes performing a remote procedure call (RPC) to generate a new data object at the feature store, the new data object having the device subscribed as a client. The method may include receiving, by the device and from the feature store in connection with the device being subscribed to the new data object as the client, a set of values associated with a composite feature, wherein the set of values is associated with the new data object, wherein the composite feature is a secondary or higher feature based on one or more primary features calculated at the feature store. The method may include executing, by the device, a machine learning model using the set of values associated with the composite feature. The method may include outputting, by the device, a machine learning prediction based on a result of executing the machine learning model using the set of values associated with the composite feature.

Some implementations described herein relate to a system for machine learning model generation and/or prediction. The system may include one or more memories and one or more processors coupled to the one or more memories configured to cause the system. The one or more processors may be configured to receive, at a server device, a request for a machine learning prediction. The one or more processors may be configured to access, from the server device, a feature store that stores data associated with a plurality of possible machine learning model features. The one or more processors may be configured to encode, at the feature store, a set of values associated with a composite feature, wherein the composite feature is a secondary or higher feature based on one or more primary features calculated at the feature store. The one or more processors may be configured to transfer, at a communication interface, the set of values between the feature store and the server device using a WebSockets protocol. The one or more processors may be configured to decode, at the server device, the set of values associated with the composite feature. The one or more processors may be configured to execute, at the server device, a machine learning model using the set of values associated with the composite feature. The one or more processors may be configured to output, from the server device, the machine learning prediction based on a result of executing the machine learning model using the set of values associated with the composite feature.

### BRIEF DESCRIPTION OF THE DRAWINGS

FIGS. 1A-1C are diagrams of an example implementation associated with a model feature engineering system, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with a model feature engineering system, in accordance with some embodiments of the present disclosure.

FIG. 4 is a flowchart of an example process associated with using a model feature engineering system, in accordance with some embodiments of the present disclosure.

### DETAILED DESCRIPTION

The following detailed description of example implementations refers to the accompanying drawings. The same reference numbers in different drawings may identify the same or similar elements.

In some server-client architectures, a server device can access data features stored in a database using application programming interfaces (APIs) or direct database queries. The databases may include structured query language (SQL) databases, which may be table-based, or non-structured query language (NoSQL) databases, which may be document, key-value, graph, or wide-column data stores. For real-time data ingestion and modification, an event streaming system may be used to form a data pipeline. Based on accessing data, the server device may use feature engineering techniques like normalization, imputation, or dimensionality reduction, among other examples, to perform a data transformation or modification. Data transformation and modification procedures may utilize numerical operations, data frame manipulations, or other, more complex transformations. Such data manipulations may be resource intensive for the server device.

For building machine learning models using the manipulated data, the server device may leverage machine learning libraries. In a healthcare context, for example, the server device may train a predictive model, such as a random forest model or gradient boosting machine (GBM) model to forecast patient outcomes based on historical health data. In a fraud detection context, the server device may train an ensemble method model or a neural network model to identify anomalous transaction patterns or login patterns, which may be indicative of a fraudulent transaction or a fraudulent use of a computing system, respectively. The server device may train such models using labeled datasets and by applying techniques, such as cross-validation, for model evaluation.

Once a model is trained and evaluated, the server device can deploy the model into a production environment using a containerization platform or a specialized machine learning deployment solution. After deployment, the model (e.g., the server device resources or a client device running the model) ingests new data features in real-time or batches, continuing to update predictions or determinations. In the healthcare context, such predictions may include updated patient risk assessments. In the fraud detection context, the model may continuously adapt to new fraud patterns. The server device may also implement feedback loops to retrain the model, ensuring that the model evolves with a changing data landscape.

However, training and retraining models using the aforementioned server-client architecture may require resource intensive tasks, which may be increasingly inefficient with the deployment of hundreds, thousands, or even millions of models. Some implementations described herein provide a system and/or architecture for machine learning model prediction. For example, a server device may use remote procedure calls (RPCs) and a WebSockets protocol to enable push-based sharing of data and engineered features between sub-systems associated with training and supporting machine learning models. In this way, by implementing the system and/or architecture, some implementations reduce a utilization of processing resources (or more efficiently distribute available processing resources) relative to other techniques or architectures. In some implementations, the server device may use a centralized data store that can generate composite features and push the composite features to the server device for use in machine learning model training and/or execution. In this way, the server device may offload some processing tasks and/or avoid duplicative processing by multiple server devices.

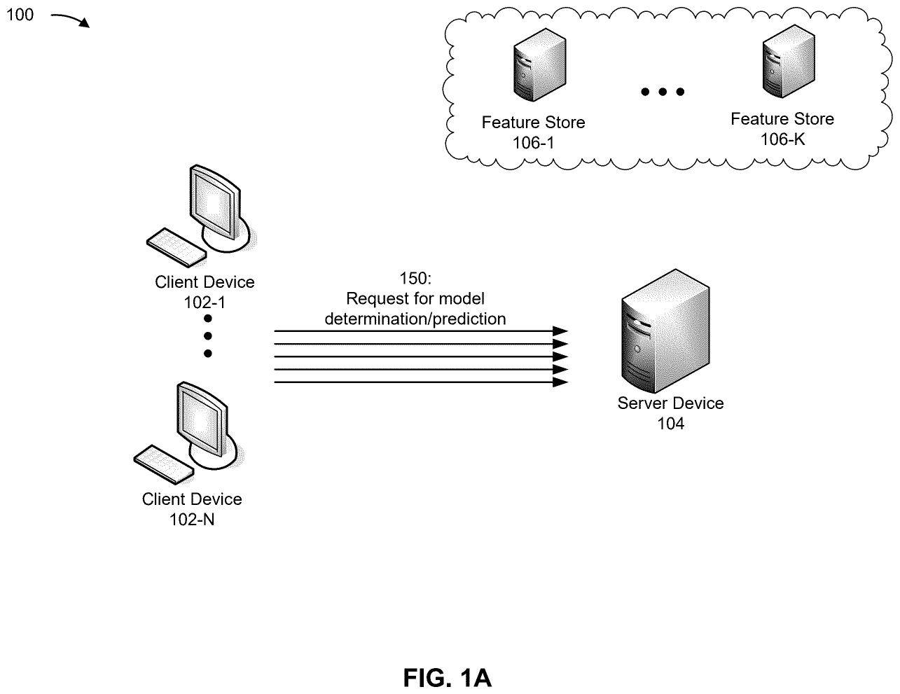

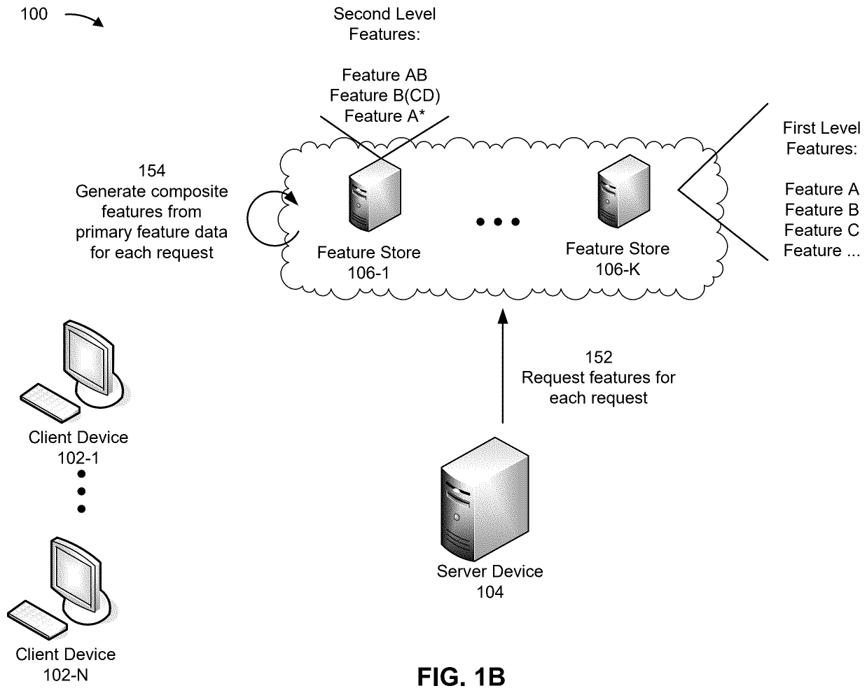

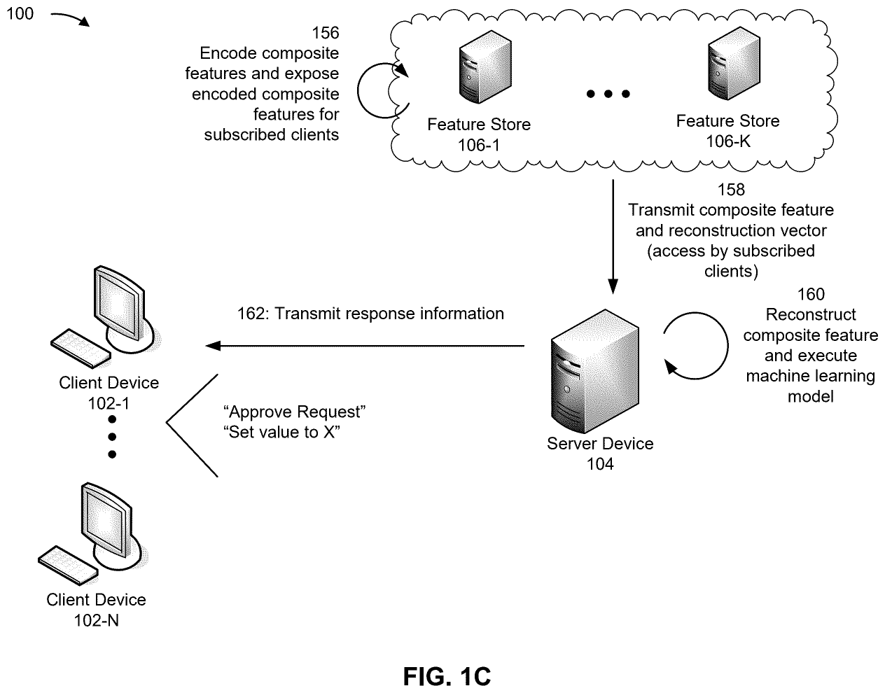

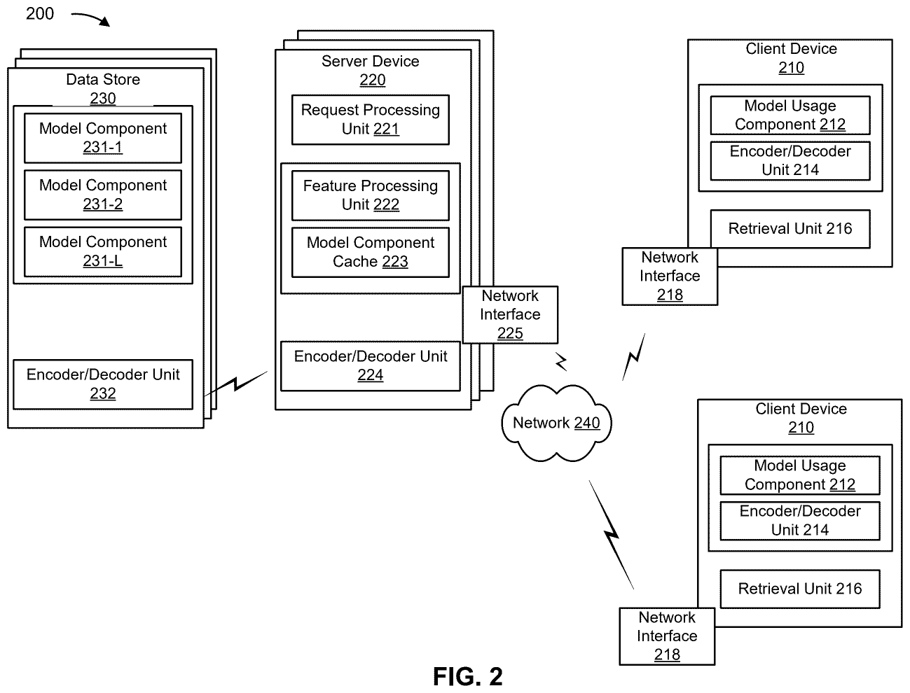

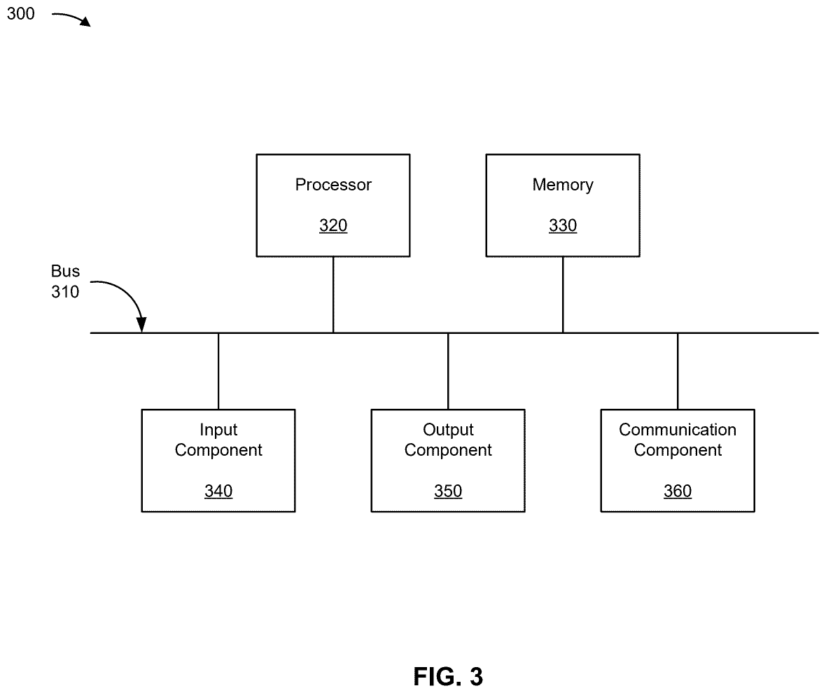

FIGS. 1A-1C are diagrams of an example implementation 100 associated with a model feature engineering system. As shown in FIGS. 1A-1C, example implementation 100 includes a set of client device 102 (e.g., client devices 102-1 through 102-N), a server device 104, and a set of feature stores 106 (e.g., feature stores 102-1 through 102-K). These devices are described in more detail below in connection with FIG. 2 and FIG. 3.

As further shown in FIG. 1A, and by reference number 150, the server device 104 may receive a request for an artificial intelligence (AI) or machine learning (ML) (AI/ML) determination or prediction. For example, the server device 104 (and/or other server devices 104, not shown, included in a common system architecture with the server device 104) may receive requests for the server device 104 to generate a prediction or perform a determination using a model. In some implementations, the server device 104 may receive a request for a prediction or determination associated with an existing model. For example, a client device 102 may store information identifying one or more trained models available via the server device 102 and may transmit a request that an existing trained model be used to generate a prediction or perform a determination. Additionally, or alternatively, the client device 102 may request that the server device 104 create (e.g., train) a model, which does not already exist, to generate predictions or perform determinations.

As shown in FIG. 1B, and by reference number 152, the server device 104 may request features associated with each request for an AI/ML determination. For example, the server device 104 may communicate with a feature store 106 to obtain feature data associated with training or using a model for a prediction or determination. In this case, the server device 104 may transmit a remote procedure call (RPC) to the feature store 106 to cause the feature store 106 to create a new data object associated with, for example, a composite feature, as described in more detail below.

In some implementations, the feature stores 106 may be included in a computing system (e.g., each feature store 106 may be a compute node of a cloud computing system) operating multiple feature stores 106, concurrently, to service multiple server devices. For example, the server device 104 may transmit a request, which may get routed to a particular feature store 106 of multiple possible feature stores 106. In some implementations, the request may be routed based on a load bearing characteristic. For example, the server device 104 may transmit the request to a feature store 106 with available processing resources or communication (e.g., network) resources for fulfilling the request. Additionally, or alternatively, the request may be routed based on a data availability. For example, different feature stores 106 may have different primary features and the server device 104 may transmit the request to a particular feature store 106 having primary features from which a desired secondary feature can be derived.

In some implementations, the feature stores 106 may be specialized. For example, each feature store 106 may be configured to perform a particular subset of possible computations associated with processing primary and/or composite features, as described below, based on requests associated with different characteristics. In this case, the server device 104 may transmit the request to a feature store 106 that is configured for performing processing to fulfill the request, such as a feature store 106 that is configured to generate a composite feature to fulfill the request. In this case, by having specialization of the feature stores 106, each feature store 106 can be implemented using fewer computing resources than if each feature store 106 is to be a general purpose feature store 106 for performing all possible calculations or computations.

As further shown in FIG. 1B, and by reference number 154, a feature store 106 may generate one or more composite features (or “secondary” features) from non-composite feature data (or “primary” feature data). A primary feature represents an original, fundamental characteristic of data that is being analyzed. As an example, in the context of predicting a price for an automobile, a primary feature might be a mileage of a car, a make of the car, or a model of the car. Other prediction contexts for primary features may include weather prediction (e.g., a temperature), mapping (e.g., distance between locations), text analysis (e.g., words or letters of a text), healthcare (e.g., blood pressure or cholesterol level), academic evaluation (e.g., student test scores), fraud evaluation (e.g., login Internet Protocol (IP) addresses) among other examples. In contrast, a composite feature can provide a more nuanced understanding of data by condensing multiple primary features into a single, informative variable. In machine learning terms, using a composite feature (e.g., which combines multiple primary features into a single value) may reduce a computing complexity and/or improve an accuracy of a prediction. As an example, in the context of predicting a price for an automobile, a composite feature might be a classification of whether the make of the car is a luxury make or a non-luxury make (e.g., which may combine both a first primary feature of the make and a second primary feature of an average initial sales price of the make).

Composite features may be determined in other prediction or determination contexts, such as weather prediction (e.g., a weather category, such as “hot,” “moderate,” or “cold”), a mapping (e.g., a travel time, which may be based on a distance between locations, a traffic condition on a route between locations, a speed limit on a route between locations, etc.), text analysis (e.g., a sentiment score), healthcare (e.g., a health risk level), student performance (e.g., a performance grade level, such as whether a student reads at, above, or below their grade level), or fraud evaluation (e.g., a fraud risk score, which may be based on login IP addresses and a quantity of incorrect login attempts). In some implementations, a composite feature may be derived from one or more other composite features. For example, a composite feature may use, as an underlying data point, a set of primary features, a set of composite features, or a combination of one or more primary features and one or more composite features. As a specific example, in a healthcare context, a health risk level may be derived based on a cardiac risk level and a cancer risk level, each of which may be derived based on a set of underlying primary features, such as age, weight, whether the patient is a smoker, family history, etc.

Returning to the example of reference number 154, the feature store 106 may derive a composite feature based on a set of primary features. For example, when the server device 104 is to perform a prediction relating to automobile price, the server device 104 may include, in the request for features, an indication that the request is related to predicting automobile price or may provide an explicit request for a composite feature to be generated. In this case, the feature store 106 may combine a plurality of primary features (e.g., make and model) relating to predicting automobile price into a single, composite feature (e.g., luxury car or non-luxury car) relating to predicting automobile price.

In some implementations, a computation may be bidirectional. For example, rather than the server device 104 performing the prediction relating to the automobile remote for the client device 102, the server device 104 may obtain and/or generate a set of model adjustments for the client device 102 to perform the prediction locally. In other words, the server device 104 may request information from the feature store 106 regarding a composite feature and use the information to update a machine learning model. In this case, the server device 104 may provide information regarding the updated machine learning model (e.g., a change to one or more weights or embeddings) to the client device 102 to enable the client device 102 to perform a prediction. In this case, a remote procedure call (RPC) may be used in connection with transforming the model and providing values that the client device 102 can use to execute a transformed or updated model. Additionally, or alternatively, server device 104 may calculate an adjustment based on a composite feature and propagate the adjustment to the client device 102. For example, the server device 104 may determine that a particular composite feature indicates a price adjustment of −$1,200 relative to a baseline price. In this case, the server device 104 may propagate the price adjustment for the composite feature (or a delta relative to a previously determined price adjustment, such as a change from −$1,000 to −$1,200) to the client device 102 which may use the price adjustment in connection with a model prediction (e.g., by changing an output of a local model of client device 102 using the price adjustment).

In some implementations, in a context of healthcare prediction, the feature store 106 may combine a plurality of primary features (e.g., age, weight, heart rate, cholesterol level) into a single composite feature (e.g., heart health). In this case, by combining a plurality of primary features into a single composite feature, the feature store 106 can compress an amount of data that is to be provided to the server device 104 for model based prediction. In other words, rather than providing 4 data points for each patient in a model (e.g., age, weight, heart rate, cholesterol level), the feature store 106 can provide a single data point, which reduces a utilization of network resources. Additionally, or alternatively, the server device 104 can process the single data point for each patient (rather than 4 data points), thereby enabling training and/or utilization of a model with a reduced utilization of computing resources (and without reducing an accuracy of predictions or determinations).

In some implementations, the feature store 106 may use a remote machine learning model to generate the composite feature. For example, the feature store 106 may train a machine learning model on a set of primary features and use the machine learning model to determine one or more combinations of features that are associated with a threshold level of predictiveness. For example, the feature store 106 may use a machine learning model to process hundreds of healthcare primary features and identify a subset of healthcare primary features with a threshold level of predictiveness. In this case, the feature store 106 may use the subset of healthcare primary features as model features for a machine learning model that generates a single composite feature representing the subset of healthcare primary features. In other words, the feature store 106 may train a model to evaluate primary features of an age, a blood pressure, and a heart rate, for example, to generate a heart disease risk composite feature.

In some implementations, the feature store 106 may provide access to information identifying available composite features. For example, the feature store 106 may indicate that a set of primary features A, B, C, and D are available as well as a set of generated composite features AB (e.g., a combination of A and B), B (CD) (e.g., a combination of primary feature B and a composite feature CD), and A*(e.g., a transformation of primary feature A). In this way, subsequent requests for composite features can forgo separate processing steps, by enabling utilization of previously generated composite features, or subscriptions to feeds that provide data associated with previously generated composite features.

As shown in FIG. 1C, and by reference number 156, the feature store 106 may encode one or more composite features and expose the encoded composite features for one or more subscribed clients. For example, the feature store 106 may deconstruct the composite feature into a set of portions and may generate code for reconstructing the set of portions back into the composite feature. In some implementations, the set of portions may represent a data compression of the composite feature (or data associated therewith). For example, the feature store 106 may represent the composite feature as a vector and may deconstruct the vector into a set of sub-vectors. In some implementations, the feature store 106 may encode a matrix representing values of a set of composite features and/or primary features as a set of portions. For example, the feature store 106 may generate a set of vectors representing sets of values of an underlying matrix and may provide the set of vectors (e.g., for reconstruction into the underlying matrix). By transmitting a compressed matrix and code for reconstructing the matrix, rather than serializing data underlying the matrix, the feature store 106 and the server device 104 may achieve reduced data traffic over a network.

As further shown in FIG. 1C, and by reference number 158, the feature store 106 may transmit one or more composite features and/or a reconstruction vector to the subscribed clients. For example, the feature store 106 may transmit a composite feature as a set of portions and the code for reconstructing the set of portions back into the composite feature. In some implementations, the feature store 106 may transmit information identifying the composite feature via a push notification of a subscribed feed. For example, when the server device 104 requests a particular composite feature, the feature store 106 may generate the particular composite feature and generate a subscription feed associated with the particular composite feature. In this case, the server device 104 subscribes to the subscription feed and, when the feature store 106 receives updated data relating to the composite feature (e.g., a new data point of a primary feature from which to generate a new composite feature value), the feature store 106 can push the new composite feature value to each server device subscribed to the subscription feed.

As further shown in FIG. 1C, and by reference number 160, the server device 104 may reconstruct the composite features and execute a machine learning model. For example, the server device 104 may use the code to reconstruct the set of portions of a composite feature into the composite feature itself. In other words, the server device 104 may use the code to deserialize the set of portions, thereby recovering the composite feature that was serialized to generate the set of portions. In this way, by deconstructing the feature into the set of portions and conveying reconstruction information with the set of portions to the server device 104, the feature store 106 is enabled to be agnostic as to an environment of the server device 104. In other words, the feature store 106 can be universally used with different types of compilers at the server device 104 side.

In some implementations, the server device 104 and/or the feature store 106 may use a remote procedure call (RPC) to perform the serialization and/or deserialization procedure. For example, the feature store 106 or the server device 104 may transmit an RPC that includes instructions for reconstructing a vector, such as the composite feature, from a set of deconstructed portions. In some implementations, the server device 104 may use a WebSockets protocol to perform parallel reconstruction of the composite feature. For example, a plurality of server devices 104 may subscribe to the composite feature using WebSockets and may share data across the plurality of server devices 104 in parallel using WebSockets. In this case, when the composite feature is to be reconstructed from a set of serialized portions, a plurality of server devices 104 can, in parallel, perform computations to complete the reconstruction. Additionally, or alternatively, the server device 104 and the feature store 106 may use another protocol for asynchronous communications for distributing data associated with composite features and/or a model.

In some implementations, the server device 104 may generate or retrain a model. For example, the server device 104 may perform initial training of a model using a set of primary features and/or composite features. Additionally, or alternatively, the server device 104 may retrain an existing model using updated data associated with a set of primary features and/or composite features. In some implementations, the server device 104 may perform a prediction or generate a determination using a model. For example, the server device 104 may use a model to generate an output, such as an automobile price, a healthcare diagnosis, a document analysis, a fraud determination or authentication, a manufacturing process control signal, or another output.

As further shown in FIG. 1C, and by reference number 162, the server device 104 may transmit response information to the client devices 102. For example, the server device 104 may transmit information identifying the output of the model. Additionally, or alternatively, the server device 104 may transmit an instruction associated with the output of the model. For example, the server device 104 may transmit a control instruction to a control client device 102 of a manufacturing process. Additionally, or alternatively, the server device 104 may transmit information identifying a set of commands for a medical client device 102 to enable the medical client device 102 to obtain additional measurements to confirm a predicted diagnosis. In some implementations, the server device 104 may deploy the model to the client device 102. For example, based on training the model, the server device 104 may transmit a set of embeddings of the model to the client device 102 to enable the client device 102 to use the model for prediction or determination.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

FIG. 2 is a diagram of an example environment 200 in which systems and/or methods described herein may be implemented. As shown in FIG. 2, environment 200 may include a client device 210, a server device 220, a data store 230, and a network 240. Devices of environment 200 may interconnect via wired connections, wireless connections, or a combination of wired and wireless connections.

The client device 210 may include one or more devices capable of receiving, generating, storing, processing, and/or providing information associated with using a machine learning model, as described elsewhere herein. The client device 210 may include a communication device and/or a computing device. For example, the client device 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

In some implementations, the client device 210 may include a model usage component 212, an encoder/decoder unit 214, a retrieval unit 216, and/or a network interface 218. The model usage component 212 may execute a machine learning model that is deployed to a client device 210 or may generate a request that the server device 220 generate and/or use a model for the client device 210. The encoder/decoder unit 214 may use RPCs (or be subject to RPCs) associated with encoding data as a set of data portions (e.g., code) and reconstruction information for reconstructing the set of data portions into the data. For example, the client device 210 may use the encoder/decoder unit 214 to reconstruct a matrix of values associated with a set of composite features that was deconstructed into a set of vectors or other portions. The retrieval unit 216 may use the network interface 218 to obtain data from the server device 220 and the data store 230. For example, the retrieval unit 216 may subscribe to a data feed and/or access the server device 220 to obtain a model or a prediction or determination associated therewith.

The server device 220 may include one or more devices capable of receiving, generating, storing, processing, providing, and/or routing information associated with a model feature engineering system, as described elsewhere herein. The server device 220 may include a communication device and/or a computing device. For example, the server device 220 may include a server, such as an application server, a client server, a web server, a database server, a host server, a proxy server, a virtual server (e.g., executing on computing hardware), or a server in a cloud computing system. In some implementations, the server device 220 may include computing hardware used in a cloud computing environment.

In some implementations, the server device 220 may include a request processing unit 221, a feature processing unit 222, a model component cache 223, an encoder/decoder unit 224, and a network interface 225. The request processing unit 221 may receive a request from the client device 210 for a prediction or determination and may initiate generation, retraining, or usage of a model to fulfil the request. The feature processing unit 222 may process one or more features to generate, retrain, or use a model to fulfill a request. The model component cache 223 may store information identifying features of a model, embeddings of a model, or other information relating to a model to enable usage of the model. The encoder/decoder unit 224 may decode data from the data store 230, such as composite feature data, based on, for example, reconstruction information or a reconstruction instruction received from the data store 230. Additionally, or alternatively, the encoder/decoder unit 224 may encode information for the client device 210, such as by compressing a model for deployment on the client device 210. In some implementations, a server device 220 may be a compute node that performs processing for the data store 230, which may be associated with multiple different compute nodes corresponding to multiple different server devices 220. For example, a first server device 220 may request a composite feature from the data store 230, which may instruct a second server device 220 (e.g., with available processing resources) to process a set of primary features and generate the composite feature. In this case, the second server device 220 may encode the composite feature and provide the encoded composite feature to the data store 230, which may make the composite feature available to the first server device 220 (and/or any other server devices 220 that subscribe to a data feed associated with the composite feature). In some implementations, a server device 220 may select one or more compute nodes of one or more data stores 230 to generate a composite feature based on a particular configuration of the one or more compute nodes. For example, a server device 220 may determine that a particular data store 230 includes a compute node configured to perform a particular type of computation on one or more primary features and that the particular type of computation is associated with a characteristic of a request for machine learning prediction. In this case, the server device 220 may instruct the data store 230 to select the compute node, from a plurality of compute nodes, for processing a request to generate the composite feature from the primary feature by performing the particular type of computation. Additionally, or alternatively, the server device 220 may direct a request for a composite feature to a particular compute node or data store 230 based on a characteristic of a request or a type of computation that is to be performed. The network interface 225 may enable communication, by the server device 220, with the client device 210 (e.g., via the network 240 and the network interface 218).

The data store 230 may include one or more devices capable of receiving, generating, storing, processing, and/or providing information associated with a model feature engineering system, as described elsewhere herein. The data store 230 may include a communication device and/or a computing device. For example, the data store 230 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data store 230 may communicate with one or more other devices of environment 200, as described elsewhere herein.

In some implementations, the data store 230 may be a feature store that provides information associated with features for model training and/or utilization. For example, the data store 230 may include a set of model components 231-1 through 231-L and an encoder/decoder unit 232. The model components 231-1 through 231-L may represent primary features and/or composite features for use in a machine learning or artificial intelligence model. The encoder/decoder unit 232 may encode features (e.g., a matrix of values representing a composite feature) and transmit the encoded features to the server device 220 for decoding (e.g., reconstruction).

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with a model feature engineering system. The device 300 may correspond to the client device 210, the server device 220, and/or the data store 230. In some implementations, the client device 210, the server device 220, and/or the data store 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

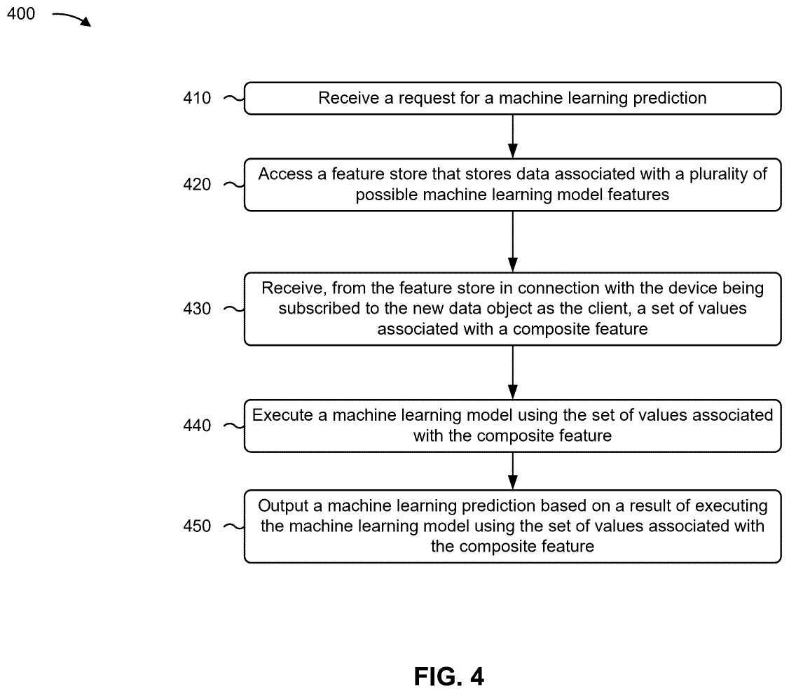

FIG. 4 is a flowchart of an example process 400 associated with using a model feature engineering system. In some implementations, one or more process blocks of FIG. 4 may be performed by the server device 220. In some implementations, one or more process blocks of FIG. 4 may be performed by another device or a group of devices separate from or including the server device 220, such as the client device 210 and/or the data store 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving a request for a machine learning prediction (block 410). For example, the server device 220 (e.g., using processor 320, memory 330, input component 340, and/or communication component 360) may receive a request for a machine learning prediction, as described above in connection with reference number 150 of FIG. 1A. As an example, the server device 220 may receive a request to predict an automobile price for generating an automobile loan policy.

As further shown in FIG. 4, process 400 may include accessing a feature store that stores data associated with a plurality of possible machine learning model features (block 420). For example, the server device 220 (e.g., using processor 320 and/or memory 330) may access a feature store that stores data associated with a plurality of possible machine learning model features, as described above in connection with reference number 152 of FIG. 1B. As an example, the server device 220 may request a composite feature, such as a feature identifying whether a particular make of car is a luxury car or a non-luxury car, which is based on primary features, such as initial sales price, available options, model types, etc. In some implementations, accessing the feature store includes performing a remote procedure call (RPC) to generate a new data object at the feature store, the new data object having the device subscribed as a client. For example, the server device 220 may use RPCs to cause a data store 230 to generate a data object for the composite feature, which the server device 220 can subscribe to. Based on the server device 220 subscribing to the data object for the composite feature, the server device 220 receives data associated with the composite feature on a push basis, rather than a pull basis (e.g., without the server device 220 explicitly requesting the data).

As further shown in FIG. 4, process 400 may include receiving, from the feature store in connection with the device being subscribed to the new data object as the client, a set of values associated with a composite feature (block 430). For example, the server device 220 (e.g., using processor 320, memory 330, input component 340, and/or communication component 360) may receive, from the feature store in connection with the device being subscribed to the new data object as the client, a set of values associated with a composite feature, as described above in connection with reference number 158 of FIG. 1C. As an example, the server device 220 may receive encoded values corresponding to a composite feature and may decode the values using reconstruction information received in connection with the values. In some implementations, the set of values is associated with the new data object and the composite feature is a secondary or higher feature based on one or more primary features calculated at the feature store. For example, the composite feature may be a secondary feature (e.g., based on primary features) or a higher feature (e.g., a feature based at least in part on a secondary feature). In some implementations, calculations of the composite feature are performed at the data store 230 or a compute node associated therewith.

As further shown in FIG. 4, process 400 may include executing a machine learning model using the set of values associated with the composite feature (block 440). For example, the server device 220 (e.g., using processor 320 and/or memory 330) may execute a machine learning model using the set of values associated with the composite feature, as described above in connection with reference number 160 of FIG. 1C. As an example, the server device 220 may use the composite feature data indicating whether different models of car are luxury models or non-luxury models as input to a machine learning model to predict an automobile price for a particular car for which an automobile loan is to be issued.

As further shown in FIG. 4, process 400 may include outputting a machine learning prediction based on a result of executing the machine learning model using the set of values associated with the composite feature (block 450). For example, the server device 220 (e.g., using processor 320, memory 330, and/or output component 350) may output a machine learning prediction based on a result of executing the machine learning model using the set of values associated with the composite feature, as described above in connection with reference number 162 of FIG. 1C. As an example, the server device 220 may transmit information indicating the automobile price and/or approval of a loan associated therewith.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device for machine learning model prediction, comprising:
one or more memories; and
one or more processors, coupled to the one or more memories, configured to cause the device to:
receive a request for a machine learning prediction;
access a feature store that stores data associated with a plurality of possible machine learning model features;
receive, from the feature store, a set of values associated with a composite feature using a protocol associated with pushing model data to subscribed client devices,
wherein the composite feature is a secondary or higher feature based on one or more primary features calculated at the feature store;
execute a machine learning model using the set of values associated with the composite feature to obtain the machine learning prediction using a result of executing the machine learning model using the set of values associated with the composite feature; and
output the machine learning prediction to permit the machine learning prediction to be used to perform one or more actions.

2. The device of claim 1, wherein the composite feature is based on an output of a remote machine learning model at the feature store.

3. The device of claim 1, wherein the feature store is implemented as a plurality of compute nodes across a plurality of server devices.

4. The device of claim 3, wherein the one or more processors, to cause the device to access the feature store, are configured to cause the device to:
select a compute node, of the plurality of compute nodes, with a particular configuration based on a characteristic of the request for the machine learning prediction; and
access the features store via a server device, of the plurality of server devices, associated with the compute node.

5. The device of claim 1, wherein the one or more processors, to cause the device to access the feature store, are configured to cause the device to:
transmit a remote procedure call (RPC) using a WebSockets protocol to access one or more resources associated with the feature store.

6. The device of claim 1, wherein the request for the machine learning prediction is directed to the device based on a characteristic of the request for the machine learning prediction,
wherein the device is included in a set of devices that is configured to process requests associated with different characteristics.

7. The device of claim 1, wherein the one or more processors are further configured to cause the device to:
reconstruct the set of values using a reconstruction instruction received in connection with the set of values; and
wherein the one or more processors, when configured to cause the device to execute the machine learning model, are configured to cause the device to:
execute the machine learning model using reconstructing the set of values.

8. A method of machine learning model prediction, comprising:
receiving, by a device, a request for a machine learning prediction;
accessing, by the device, a feature store that stores data associated with a plurality of possible machine learning model features,
wherein accessing the feature store comprises: performing a remote procedure call (RPC) to generate a new data object at the feature store, the new data object having the device subscribed as a client;
receiving, by the device and from the feature store in connection with the device being subscribed to the new data object as the client, a set of values associated with a composite feature,
wherein the set of values is associated with the new data object,
wherein the composite feature is a secondary or higher feature based on one or more primary features calculated at the feature store;
executing, by the device, a machine learning model using the set of values associated with the composite feature; and
outputting, by the device, a machine learning prediction based on a result of executing the machine learning model using the set of values associated with the composite feature.

9. The method of claim 8, wherein the composite feature is based on an output of a remote machine learning model at the feature store.

10. The method of claim 8, wherein the feature store is implemented as a plurality of compute nodes across a plurality of server devices.

11. The method of claim 10, wherein accessing the feature store comprises:
selecting a compute node, of the plurality of compute nodes, with a particular configuration based on a characteristic of the request for the machine learning prediction; and
accessing a server device, of the plurality of server devices, associated with the compute node.

12. The method of claim 8, wherein accessing the feature store comprises:
transmitting a remote procedure call (RPC) using a WebSockets protocol to access one or more resources associated with the feature store.

13. The method of claim 8, wherein the request for the machine learning prediction is directed to the device based on a characteristic of the request for the machine learning prediction,
wherein the device is included in a set of devices that is configured to process requests associated with different characteristics.

14. A system for machine learning model generation, the system comprising:
one or more memories; and
one or more processors, coupled to the one or more memories, configured to cause the system to:
receive, at a server device, a request for a machine learning prediction;
access, from the server device, a feature store that stores data associated with a plurality of possible machine learning model features;
encode, at the feature store, a set of values associated with a composite feature,
wherein the composite feature is a secondary or higher feature based on one or more primary features calculated at the feature store;
transfer, at a communication interface, the set of values between the feature store and the server device using a WebSockets protocol;
decode, at the server device, the set of values associated with the composite feature;
execute, at the server device, a machine learning model using the set of values associated with the composite feature; and
output, from the server device, the machine learning prediction based on a result of executing the machine learning model using the set of values associated with the composite feature.

15. The system of claim 14, wherein the one or more processors, to cause the system to output the machine learning prediction, are configured to cause the system to:
output the machine learning prediction to a retrieval unit of a client device.

16. The system of claim 15, wherein the machine learning prediction is encoded for decoding by a decoder unit of the client device.

17. The system of claim 14, wherein the feature store is implemented as a plurality of compute nodes across a plurality of server devices.

18. The system of claim 17, wherein the one or more processors, to cause the system to access the feature store, are configured to cause the system to:
select a compute node, of the plurality of compute nodes, with a particular configuration based on a characteristic of the request for the machine learning prediction; and
access a resources, of the plurality of server devices, associated with the compute node.

19. The system of claim 14, wherein the one or more processors, to cause the system to access the feature store, are configured to cause the system to:
transmit a remote procedure call (RPC) using the WebSockets protocol to access one or more resources associated with the feature store.

20. The system of claim 14, wherein the request for the machine learning prediction is directed to the server device based on a characteristic of the request for the machine learning prediction,
wherein the server device is included in a set of servers devices of the system that is configured to process requests associated with different characteristics.
